(19) United States
(12) Patent Application Publication
(10) Pub. No.: US 2003/0042273 A1
(43) Pub. Date: Mar. 6, 2003

(54) Portable dispensing device

(76) Inventor: Alexander J. House, Payson, IL (US)

Correspondence Address: COOK, ALEX, MCFARRON, MANZO, CUMMINGS & MEHLER LTD, SUITE 2850, 200 WEST ADAMS STREET, CHICAGO, IL, 60606, US

(21) Appl. No.: 09/943,299

(22) Filed: Aug. 31, 2001

(51) Int. Cl. G01F 11/06

(52) U.S. Cl. 222/333; 222/413; 222/626

(57) ABSTRACT

A portable dispensing device includes a hopper, a rotatable auger, a drive unit, and a rigid base. The hopper defines a receptacle including an upper opening for receiving a large quantity of bulk material and a lower opening for dispensing measured quantities of bulk material. The rotatable auger is positioned at the lower opening of the hopper for controlling the amount of bulk material which is dispensed from the hopper. The drive unit controls rotatable movement of the auger. The rigid base carries and provides support for the portable dispensing device during portable movement thereof. The portable dispensing device also includes means for measuring the weight of the bulk materials remaining in the hopper, as well as the amount of bulk material which is dispensed from the hopper, means for controlling the drive unit, means for inputting the desired amount of bulk material to be dispensed from the hopper, means for recording, storing and displaying information about the bulk material dispensed and a history of several dispensing events.

### BACKGROUND OF THE INVENTION

The present invention relates to a portable dispensing device for dispensing bulk materials. Generally, dispensing devices receive large quantities of bulk materials and dispense them in smaller measured amounts to wherever they are needed, such as mixers or the like. Current dispensing devices are advantageous in that they hold several thousand pounds of bulk material at one time, while allowing for the dispensing of bulk materials in much smaller quantities into the mixers.

A principal problem with current dispensing devices, however, is that they are heavy and unwieldy and difficult to move to the location where the discharge of the bulk material will flow into the mixer. These dispensing devices lack the portability to be moved from location to location, as needed, for dispensing measured amounts of bulk material. Indeed, prior art dispensing devices are very large and hold a prodigious amount of bulk material so that it is impractical to move the dispensing device to numerous locations where discharge of a measured amount of bulk material is needed. Due to the large scale of these dispensing devices they must be permanently located adjacent the mixer and aligned so that they bulk material which is dispensed from the dispensing device falls into the mixer.

The present invention provides a portable dispensing device which receives a large quantity of bulk material and dispenses the bulk material in measured quantities while simultaneously allowing for portability of the dispensing device so that the dispensing device can be moved from location to location to discharge a measured amount of bulk material at different locations.

### SUMMARY OF THE INVENTION

The present invention relates to a portable dispensing device. A primary purpose of the invention is to provide a portable dispensing device which is movable to a desired location next to a mixer or the like to discharge a measured amount of bulk material.

Another purpose of the invention is to provide a portable dispensing device which receives a large quantity of bulk material and dispenses measured amounts of bulk material.

Another purpose of the invention is to provide a portable dispensing device which measures the weight of bulk material within the device and the weight of the amount of bulk material which is dispensed from the device.

Another purpose of the invention is to control when material is dispensed from the device and the speed at which it is dispensed.

Another purpose of the invention is to allow for recording, storing and displaying information about the amount of bulk material being dispensed and maintaining a history of sequential dispensing events at various locations.

Another purpose of the invention is to allow the operator to input the desired amount of bulk material which is to be dispensed from the device.

Another purpose of the invention is to provide a portable dispensing vehicle which includes a plurality of wheels attached directly or indirectly to the dispensing device for portable movement between dispensing locations.

### BRIEF DESCRIPTION OF THE DRAWINGS

The invention is illustrated diagrammatically in the following drawings wherein:

FIG. 1 is a cross section of the portable dispensing device; and

FIG. 2 is a side view of the portable dispensing device, with portions of the invention shown in section.

### DETAILED DESCRIPTION OF THE PREFERRED EMBODIMENT

The present invention relates to a portable dispensing device which receives a large quantity of bulk material and dispenses the bulk material in a measured quantity to a container, mixer or other like structure. It is noted that the invention may receive many different types of material, such as calcium carbonate and other bulk materials, which are commonly sold either in large quantities such as 2,000 lbs. or in smaller bag quantities of 50 lbs. each. The portable dispensing device may hold as much as 3,000 to 4,000 lbs. of whatever type of bulk material which is desired.

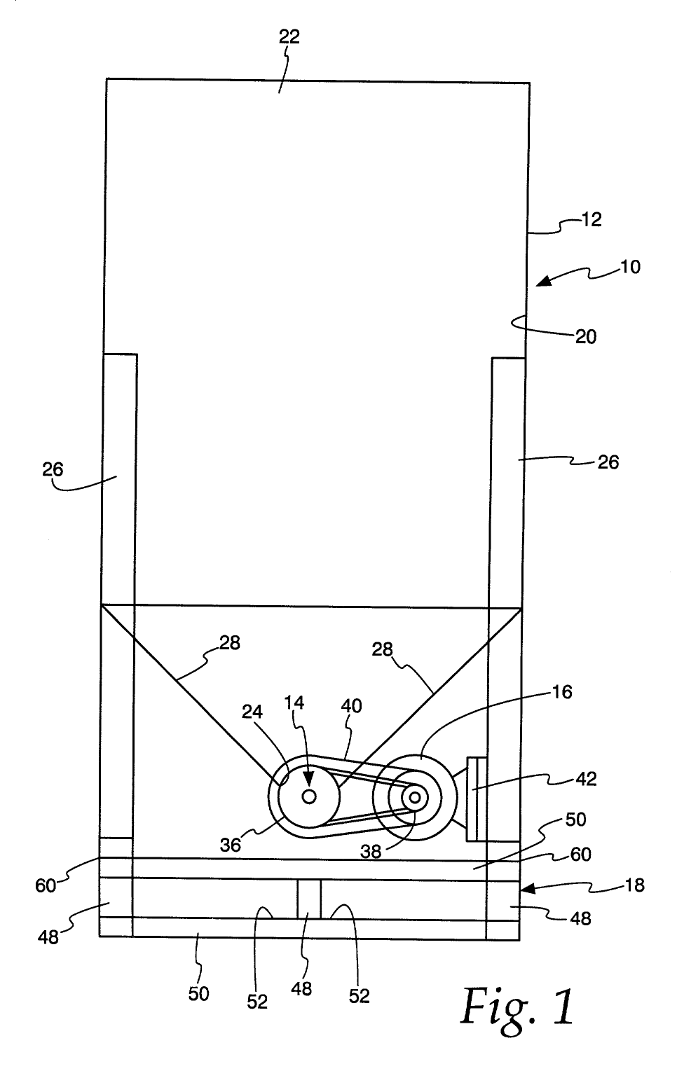

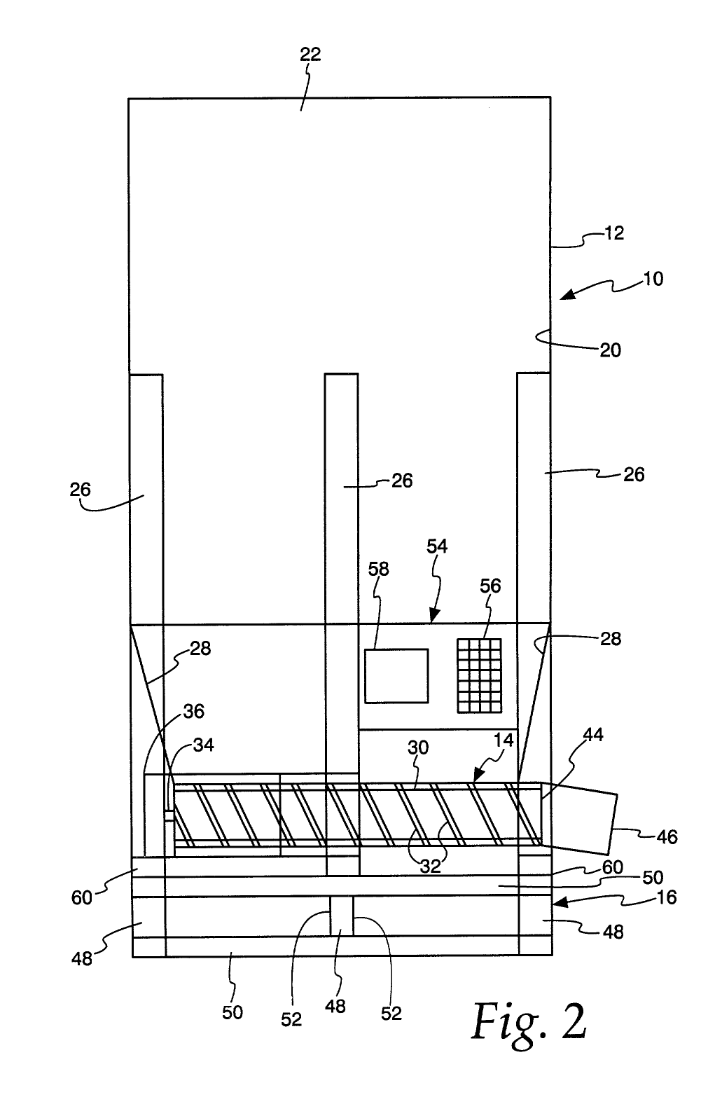

FIGS. 1 and 2 show the portable dispensing device 10 which includes a hopper 12, an auger 14, a drive unit 16, and a rigid base 18. The hopper 12 defines a generally rectangular receptacle 20 with rigid sides for holding the bulk material. There is an upper opening 22, which allows the material to be loaded into the hopper and a lower opening 24 for dispensing the bulk material. The sides of the receptacle 20 are strengthened by supporting members 26 which may be made of iron, steel, or other like materials. Near the lower opening 24 the receptacle is defined by a plurality of sloped surfaces 28 for directing the bulk materials to the lower opening 24.

Positioned in the lower opening 24 is the auger 14 which is rotatable and consists of a generally cylindrical shank 30, with a projecting edge that defines spiral channels 32. The shank 30 rotates along a spindle 34 which defines the longitudinal axis of the auger. The auger rotates about the longitudinal axis during rotational movement. The spindle 34 is connected to an annular flange 36. The annular flange 36 is connected to a drive collar 38 of the drive unit 16 via a drive belt 40. The drive unit 16 is carried by a base plate 42 which is mounted to an interior surface of the portable dispensing device 10. Although any type of drive unit is possible, the drive unit may be an electric drive motor having a suitable voltage.

When the drive unit 16 is engaged, the drive collar 38 will rotate, causing the drive belt 40 in the annular flange 36 to rotate. This in turn causes the spindle 34 to rotate the shank 30. As the shank 30 rotates, the bulk material which is placed within the hopper 12 will fill the spiral channels 32. Continued rotation of the shank 30 causes the bulk material within the spiral channels to be moved to the right in relation to the view shown in FIG. 2. The dispensed material exits the auger at a discharge outlet 44. The discharge outlets may have an extension 46 which may be made of a flexible material such as rubber, plastic or the like.

The rigid base 18 carries the portable dispensing device and provides support thereto during portable movement thereof. The rigid base has a plurality of vertical support members 48 and horizontal support members 50. The vertical and horizontal support members define drive force engaging areas 52. These drive force engaging areas may be defined as channels which allow for engagement with a forklift.

FIG. 2 shows the control unit 54 for the dispensing device which is externally located on one of the sides thereof. The control unit 54 includes an input device 56 and a display unit 58. The input device 56 allows for entry of the desired discharge weight from the portable dispensing device. Types of input devices include, but are not limited to, a keyboard, a bar code scanner, infrared imaging technology, a data port for linking the control unit to a remote computer or sensor or other like devices. The display unit 58 may be in the form of a screen display or the like.

Above the rigid base are a plurality of load sensing devices 60. These may be in the form of load cells or strain gages and provide for measurement of the weight of the bulk materials which are placed within the receptacle 20. The load sensing devices communicate with the control unit 54 so as to provide weight information continuously during dispensing of the bulk material.

The load sensing devices 60 and the control unit 54 allow for discharge of the desired measured amount of bulk material to the mixer. Before dispensing begins, the load sensors measure the weight of the bulk material within the receptacle 20 and this measurement is recorded and stored by the control unit 54 as the control unit includes logic means or a central processing unit for recording and storing data, as will be apparent to one skilled in the art. The desired discharge weight is inputted into the control unit 54 which represents the amount of bulk material which is needed by the mixer. The control unit 54 then allows for activation of the drive unit 16, which in turn activates the auger 14 and begins to dispense bulk material through the discharge outlet 44 into the mixer. The control unit may also control the speed of the drive unit to allow for faster or slower delivery of bulk material into the mixer. While the bulk material is being dispensed, the load sensing devices 60 continue to measure the weight of the portable dispensing device and communicate these measurements to the control unit so that when the weight of the amount of bulk material that is discharged through the discharge outlet 44 equals the desired discharge weight, the control unit will signal the drive unit 16 to stop the auger 14 from dispensing the material into the mixer.

The control unit 54 allows for recording, storing and displaying information about the bulk material being dispensed for numerous dispensing events. In other words, the control unit 54 maintains a history of dispensing events, as the portable dispensing device is moved from location to location for the discharge of desired amounts of bulk material. The display unit 58 allows for displaying information about the bulk material which is dispensed including the weight of the material, the duration of dispensing, the time, the date, the operator information, the batch number, the location of the dispensing device, and other dispensing information.

The present invention is advantageous in that it provides a compact, self-contained, portable dispensing device. The dispensing device has a predominantly vertical orientation and is supported at the bottom by the rigid base which has drive force engaging areas suitable for receiving the tines of a forklift so that the combination of the portable dispensing device and the vehicle equals a single portable dispensing vehicle which may be moved to a location in order to discharge a measured amount of bulk material to a mixer. The use of a forklift also allows the portable dispensing device to be raised and lowered if the entry port on the mixer is located at an elevation above the discharge outlet 44 on the portable dispensing device. It is also possible that a plurality of wheels could be mounted directly or indirectly to the rigid base 18 of the portable dispensing device for independent mobility of the device.

The material and dimensions of the portable dispensing device also aid in its portability. The portable dispensing device may be made of any suitable material such as metal or plastic. The supporting members which provide additional strength at each of the four corners, as well as on the sides, are preferred to be made of metal such as iron. The preferred dimensions of the hopper measure approximately 40″ square at its upper opening. The square column of the hopper measures about 50″ in height to the plurality of sloped surfaces, which direct the bulk material to the auger. The sloped surfaces add approximately 18″ onto the vertical height of the dispensing device. The sloped surfaces provide a self-cleaning feature so as to prevent deposition of particles along the bottom of the hopper. Two of the sloped surfaces 28, which are longitudinally disposed with respect to the auger, have an approximately slope of one-half, as indicated in FIG. 1, whereas, the two laterally disposed sloped surfaces as seen in FIG. 2 have a greater slope so as to accommodate the longitudinal length of the auger. The drive unit 16 is spaced from the auger and located beneath one of the sloped surfaces of the hopper. The control unit is disposed along one of the sides on the exterior of the hopper. The total height of the portable dispensing device is preferred to be about 82″. Thus, the portable dispensing device provides a compact, self-contained dispenser for bulk material with preferred mobility characteristics.

While the preferred form of the invention has been shown and described herein, it should be realized that there may be many modifications, alterations and substitutions thereto, without departing from the scope of the claims.

What is claimed is:

1. A portable dispensing device including:
a hopper defining a receptacle and including an upper opening for receiving a large quantity of bulk material and a lower opening for dispensing bulk material;
a rotatable auger positioned at the lower opening of the hopper for controlling the amount of bulk material which is dispensed from the hopper;
a drive unit for rotatably moving the auger; and
a rigid base for carrying the portable dispensing device during portable movement of the dispensing device.

2. The portable dispensing device of claim 1 wherein the hopper includes a plurality of sloped surfaces for directing bulk materials to the lower opening.

3. The portable dispensing device of claim 1 wherein the rigid base includes drive force engaging areas.

4. The portable dispensing device of claim 3 wherein the drive force engaging areas include one or more channels.

5. The portable dispensing device of claim 1 further including means for measuring the weight of the bulk materials remaining in the hopper .

6. The portable dispensing device of claim 1 further including means for measuring, recording, and storing the amount of bulk material dispensed from the hopper.

7. The portable dispensing device of claim 1 further including means for controlling the drive unit and rotatable movement of the auger.

8. The portable dispensing device of claim 1 further including means for inputting the desired amount of bulk material to be dispensed from the hopper.

9. The portable dispensing device of claim 1 further including means for displaying information about the bulk material dispensed from the hopper.

10. The portable dispensing device of claim 1 further including means for recording, storing and displaying information about the amount of bulk material dispensed for one or more dispensing events.

11. The portable dispensing device of claim 1 further including a vehicle having a plurality of wheels for rotatable movement wherein the rigid base is carried by the vehicle during portable movement of the dispensing device.

12. A portable dispensing vehicle including:
a hopper defining a receptacle and including an upper opening for receiving large quantities of bulk materials, a lower opening for dispensing bulk materials, and a plurality of sloped surfaces for directing bulk material to the lower opening;
a rotatable auger positioned at the lower opening of the hopper for controlling the amount of bulk material which is dispensed from the hopper;
a drive unit for rotatably moving the auger;
a control unit for controlling the drive unit, the control unit recording, storing and displaying information about the amount of bulk material remaining in the hopper and the amount of bulk material dispensed from the hopper; the control unit including an input device and a display unit;
a load sensing devise for measuring the amount of bulk material in the hopper;
a rigid base providing support to the portable dispensing vehicle during portable movement of the dispensing vehicle; and
a plurality of wheels mounted to the portable dispensing device for portable movement thereof.
